(19) United States
(12) Patent Application Publication
(10) Pub. No.: US 2010/0043722 A1
(43) Pub. Date: Feb. 25, 2010

(54) Auto-adjust pet restraint device

(76) Inventors: Cynthia M. Elkins, Ashland, WI (US); Thomas J. Gazdik, JR., Iron River, WI (US)

Correspondence Address: Thomas J. Gazdik Jr., P.O.Box 636, Iron River, WI, 54847, US

(21) Appl. No.: 12/229,735

(22) Filed: Aug. 25, 2008

(51) Int. Cl. A01K 1/06

(52) U.S. Cl. 119/814

(57) ABSTRACT

Often it is necessary to restrain pets while they are groomed, or bathed, or dried after bathing, or examined by a veterinarian, or while being exercised outdoors, etc. The auto-adjust pet restraining device applies a uniform pressure around the entire perimeter of the neck when a pet is restrained in the neck area. When the auto-adjust pet restraining device is utilized to restrain the body of a pet, the device applies a uniform pressure around the entire perimeter of that body area. The auto-adjust pet restraining device uses a design that enables pets to be restrained in a very humane way.

### FIELD OF THE INVENTION

This invention relates generally to the field of pet restraint devices.

### SUMMARY AND OBJECTS OF THE INVENTION

Often it is necessary to restrain pets while they are groomed, or bathed, or dried after bathing, or examined by a veterinarian, or while being exercised outdoors, etc. Many pet restraining devices are uncomfortable for pets and some may injure pets. The auto-adjust pet restraining-device applies a uniform pressure around the entire perimeter of the neck when a pet is restrained in the neck area. When the auto-adjust pet restraining device is utilized to restrain the body of a pet, the device applies a uniform pressure around the entire perimeter of that body area. The auto-adjust pet restraining device uses a design that enables pets to be restrained in a very humane way.

The auto-adjust pet restraining device is self adjusting so as to accommodate many different sizes of pets and automatically adjusts to apply a uniform pressure around the entire perimeter of the neck or the entire perimeter of the body when a pet is being restrained.

### BRIEF DESCRIPTION OF THE DRAWINGS

In order that the manner in which the above and other objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying annexed drawings wherein:

FIG. 1. Is a top view of the new auto-adjust pet restraining device.

FIG. 2. Is a front view of the auto-adjust pet restraining device hanging from a grooming arm.

FIG. 3. Is a front view of the auto-adjust pet restraining device hanging from a grooming arm. A dog is on top of a grooming table and is restrained by the auto-adjust restraining pet device.

FIG. 4. Is a close up side view of a dog restrained by the auto-adjust restraining device.

FIG. 5. Is a close up back view of a dog restrained by the auto-adjust restraining device.

FIG. 5A. Is a close up of an alternate strap design for a auto-adjust restraining device.

FIG. 5B. Is a close up of an alternate strap design for a auto-adjust restraining device.

FIG. 6. Is a side view of two auto-adjust pet restraining devices. The second auto-adjust pet restraining device is snapped to a ring on the first auto-adjust pet restraining device.

FIG. 7. Is a close up view of two auto-adjust pet restraining devices. The second auto-adjust pet restraining device is snapped to a ring on the first auto-adjust pet restraining device.

FIG. 8. Is a front view of two auto-adjust pet restraining devices hanging from a grooming arm.

FIG. 9. Is a front view of two auto-adjust pet restraining devices hanging from a grooming arm. A dog is on top of a grooming table and is restrained by the two auto-adjust restraining devices.

FIG. 10. Is a closeup view of a dog restrained by the two auto-adjust pet restraining devices.

FIG. 11. Is a side view of a dog restrained by the auto-adjust pet restraining device. This shows how a loop on the multi-use restraining device can fit a hand so that the auto-adjust restraining device can be utilized as a leash.

FIG. 12. Is a top view of two prior art pet restraining device.

FIG. 13. Is a front view of a prior art pet restraining device hanging from a grooming arm.

FIG. 14. Is a front view of a prior art pet restraining device hanging from a grooming arm. A dog is on top of a grooming table and is restrained by the prior art pet restraining device.

FIG. 15. Is a front view of two prior art pet restraining devices hanging from a grooming arm.

FIG. 16. Is a front view of two prior art pet restraining devices hanging from a grooming arm. A dog is on top of a grooming table and is restrained by the two prior art restraining devices.

FIG. 17. Is a closeup side view of a dog being restrained by two prior art pet restraining devices.

The objects and advantages of the invention will become apparent when the drawings are studied in conjunction with reading the following description and the claims.

### DESCRIPTION OF THE PREFERRED EMBODIMENTS

In keeping with the requirements of Patent Laws there is described herein below the best mode of the invention that is currently known to the applicant. For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

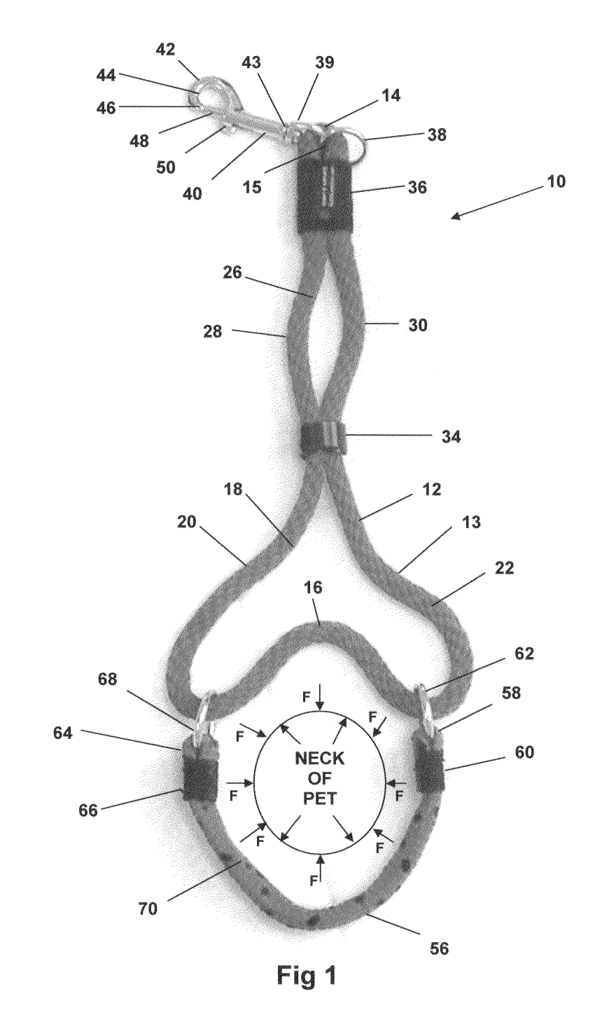

With reference now to the drawings, and in particular, to FIGS. 1-17 thereof, the preferred embodiment of the new auto-adjust pet restraining device embodying the principles and concepts of the present invention and generally designated by the reference number 10 will be described.

In FIG. 1 shown generally at 10 is a top view of the new auto-adjust pet restraining device 12. The main loop 13 has a first end 14 and a second end 16. Main loop 13 has a first loop 18 that has first side 20 and a second side 22. Main loop 13 has a second loop 26 that has first side 28 and a second side 30. Sliding snugger 34 slides along main first loop 13 and forms first loop 18 and second loop 26. Rope retainer 36 fastens ends of rope and form a top loop 15. Top loop 15 encircles ring 38 and hook loop 39 of hook 40. Hook 40 has end that opens 42. Hook 40 has swivel 43. Hook 40 has curved hook section 44 with end 46, sliding pin 48, and knob 50. Strap 56 has a first end 58 that has fastening material 60 and ring 62. Strap 56 has second end 64 that has fastening material 66 and ring 68. A loop 70 is formed that restrains pet between end 16 of main loop 13 and strap 56. The circle inside loop 70 shows how the neck of a pet would be positioned inside loop 70. The arrows show how the restraining forces would be evenly distributed around the entire perimeter of the pets neck when loop 70 is tight.

Auto-adjust pet restraining devices can be make of a variety of sizes and of a variety of materials and optional designs.

Auto-adjust pet restraining devices can be make of a variety of sizes such as small, medium, large, and extra large. Also an auto-adjust restraining device can be made in a custom size for a special application.

Auto-adjust pet restraining devices can be make of a variety of material and combinations thereof.

For example the flexible loops could be made of nylon, or polypropylene, or other plastic materials, or hemp, or leather, etc.

The flexible loops have a round shape, or a flat shape, and could be made of different diameters and widths of nylon, or polypropylene, or other plastic materials, or hemp, or leather, etc.

The flexible loops could be made of different colors and/or combination of colors.

The rings could be made of brass, or stainless steel, or plastic, or other materials. The hook could be made of brass, or stainless steel, or plastic, or other materials.

The ends of the flexible loops could be fastened by different methods.

Different labels could be incorporated onto the device for different customers.

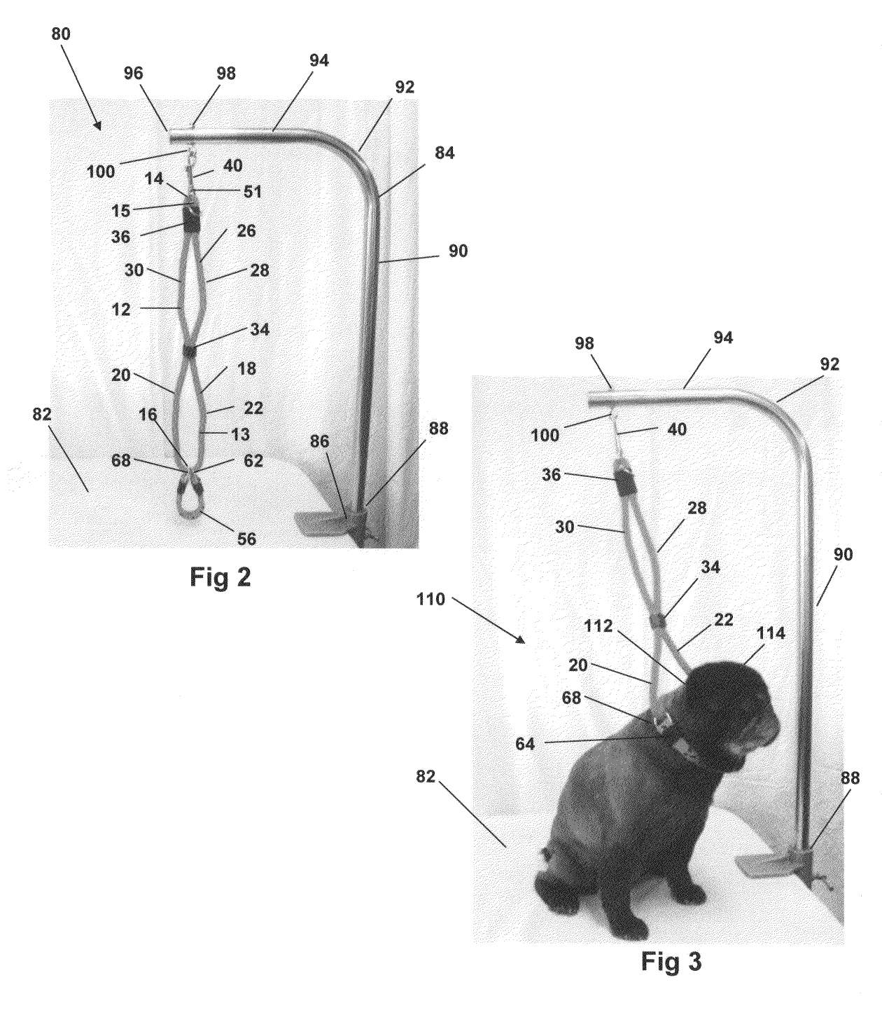

In FIG. 2. Shown generally at 80 is a front view of the auto-adjust pet restraining device 12 hanging from a grooming arm 94. The main loop 13 has a first end 14 and a second end 16. Main loop 13 has a bottom loop 18 that has first side 20 and a second side 22. Main loop 13 has a top loop 26 that has first side 28 and a second side 30. Sliding snugger 34 slides along main loop 13 and forms bottom loop 18 and top loop 26. Rope retainer 36 fastens ends of rope and form a fastening loop 15. Fastening loop 15 encircles ring 38 and hook loop 39 of hook 40. Strap 56 has a first end ring 62. Strap 56 has second end ring 68. A loop 70 is formed that restrains pet between end 16 of main loop 13 and strap 56. Surface of grooming table 82 is where a pet would be positioned. Grooming arm 84 has a clamping device 86 at the base 88 where the grooming arm 84 is fastened to grooming table 82. Grooming arm 84 has a vertical section 90 a curved section 92 and a horizontal section 94. Grooming arm terminates in end 96 and has bolt 98 that has a loop 100 that hook 40 of the auto-adjust grooming device 13 can be fastened thereto.

Shown generally at 110 in FIG. 3 is a front view of the auto-adjust pet restraining device 12 hanging from a grooming arm 94 with a dog 114 is being restrained by the auto-adjust restraining device. The main loop 13 has a first end 14 and a second end 16. Main loop 13 has a bottom loop 18 that has first side 20 and a second side 22. Main loop 13 has a top loop 26 that has first side 28 and a second side 30. Sliding snugger 34 slides along main first loop 13 and forms bottom loop 18 and top loop 26. Fastening loop 15 encircles ring 38 and hook loop 39 of hook 40. Strap 56 is positioned around neck 112 of dog 114. Strap 56 has a first end 58 that has ring 62. Strap 56 has second end 64 that has ring 68. A loop 70 is formed that restrains pet between is end 16 of main loop 13 and strap 56. Dog 114 is positioned on surface of grooming table 82. Grooming arm 84 has a clamping device 86 at the base 88 where the grooming arm 84 is fastened to grooming table 82. Grooming arm 84 has a vertical section 90 a curved section 92 and a horizontal section 94. Grooming arm terminates in end 96 and has bolt 98 that has a loop 100 that hook 40 of the auto-adjust grooming device 13 is hooked thereto.

Shown generally at 120 in FIG. 4. Is a close up side view of a dog 114 restrained by the auto-adjust restraining device 12. Bottom loop 18 has first side 20 and a second side 22. Strap 56 has a first end 58 (not seen) that has ring 62. Strap 56 has second end 64 that has ring 68. Sliding snugger 34 slides along main first loop. A loop 70 is formed that restrains neck 112 of dog 114 between end 16 of main loop 13 and strap 56.

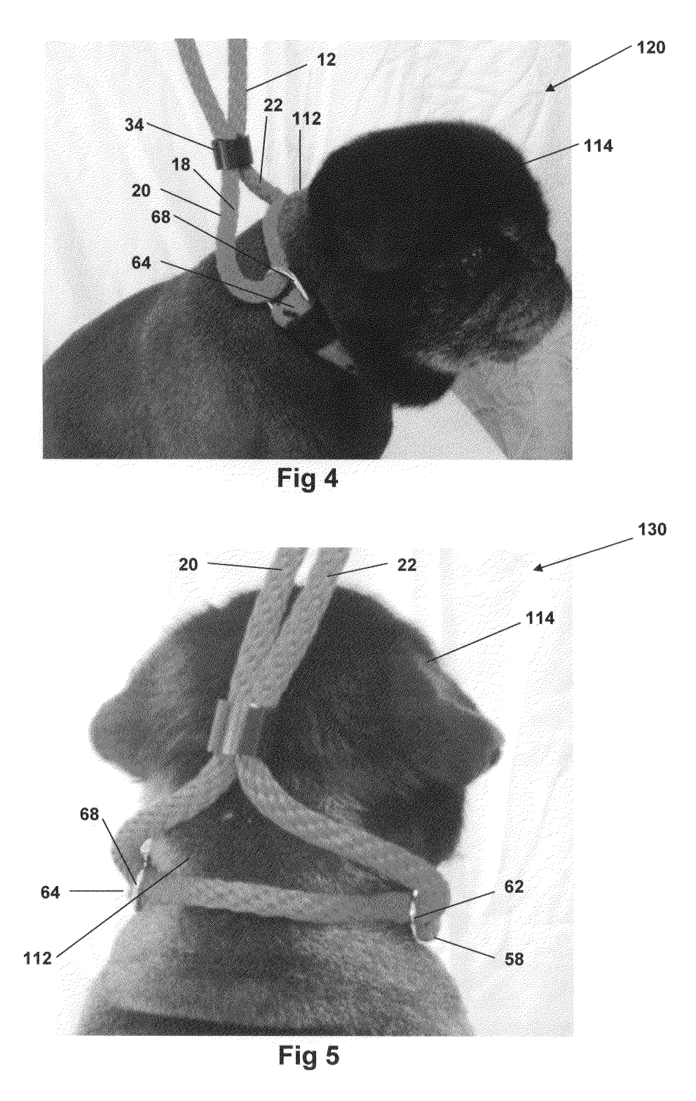

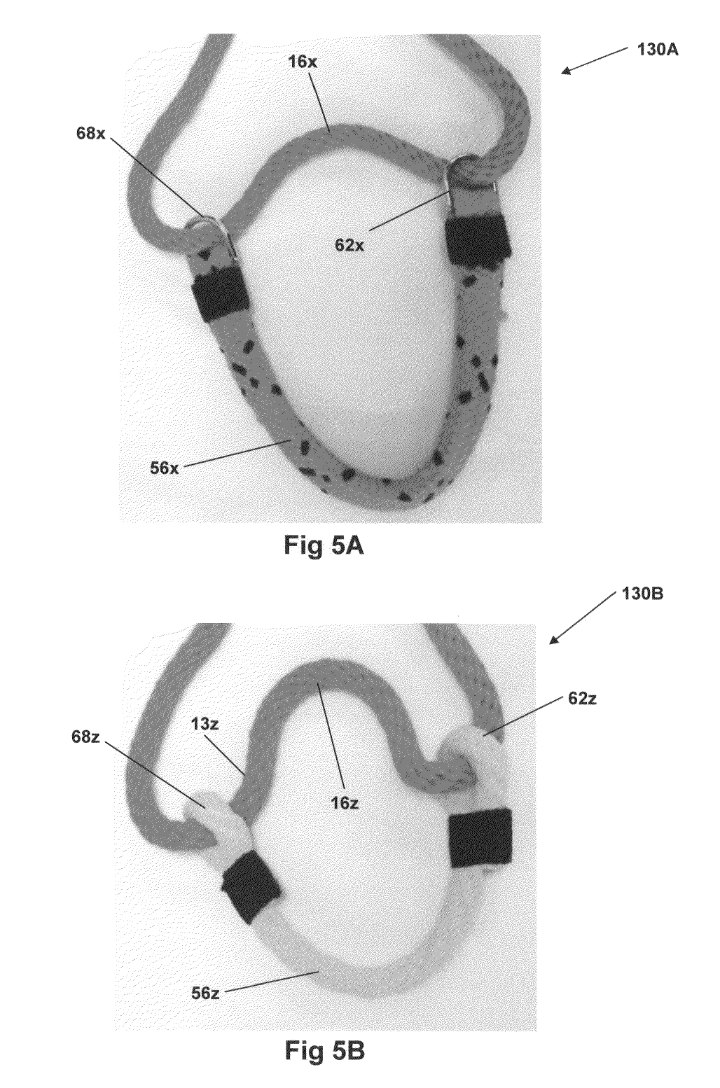

Shown generally at 130 in FIG. 5. Is a close up back view of a dog 114 restrained by the auto-adjust restraining device 12. Bottom loop 18 has first side 20 and a second side 22. Strap 56 has a first end 58 that has ring 62. Strap 56 has second end 64 that has ring 68. A loop 70 is formed that restrains neck 112 of dog 114 between end 16 of main loop 13 and strap 56.

Shown generally at 130A in FIG. 5A is a close up of an alternate strap design for a auto-adjust restraining device. Strap 56x has a first end that has a “D” ring 62x and a second end that has a “D” ring 68x. A wide variety of different ring designs could be utilized on various embodiments of auto-adjust restraining devices.

Shown generally at 130B in FIG. 5B. Is a close up of an alternate strap design for a auto-adjust restraining device. Strap 56z has a first end that has a loop 62z that is made of the same material as strap 56z. Strap 56z has a second end that has a loop 68z that is made of the same material as strap 56z. The loop is sized so that the loop slides freely along loop 13z.

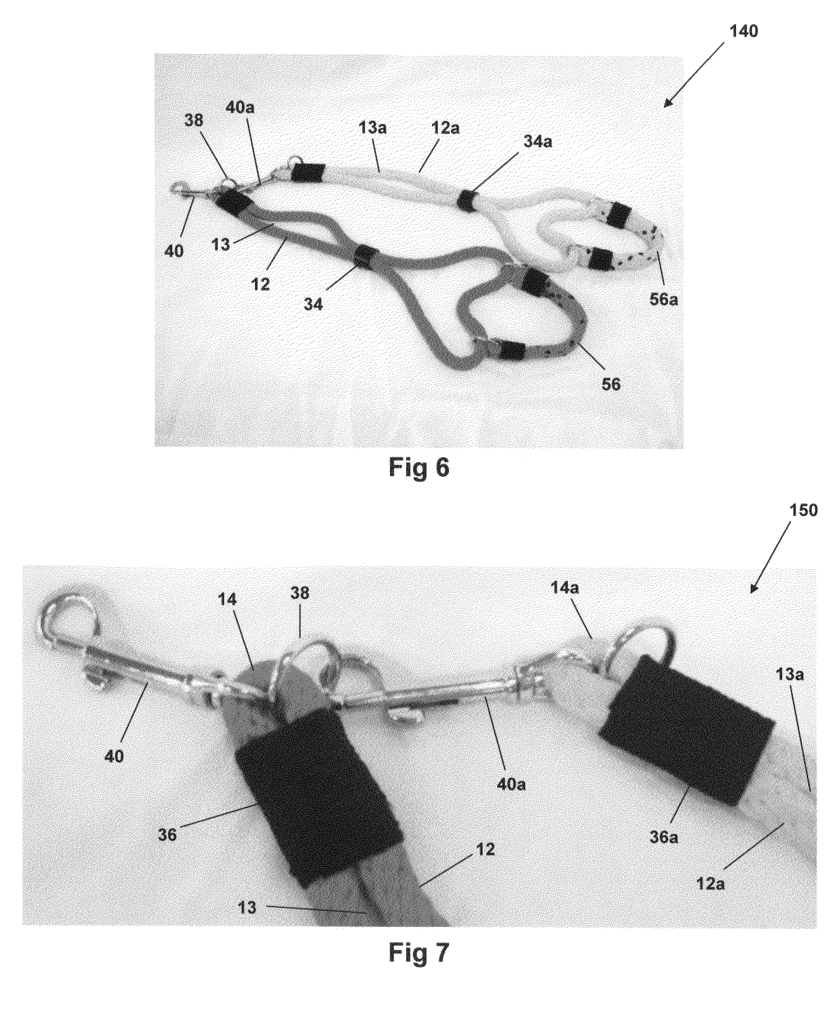

Shown generally at 140 in FIG. 6. is a top view of a first auto-adjust pet restraining device 12 and a second auto-adjust pet restraining device 12a. The second auto-adjust pet restraining device 12a has hook 40a snapped onto ring 38 first multi-use pet restraining device 12. First auto-adjust pet restraining device 12 is substantially the same auto-adjust pet restraining device 12 discussed in FIG. 1 thru 5 which has main loop 13 strap 56, ring 38, hook 40 and sliding snugger 34. Second multi-use pet restraining device 12a is substantially the same as auto-adjust pet restraining device 12.

Shown generally at 150 in FIG. 7 is a closeup view of a part of a first auto-adjust pet restraining device 12 and a second auto-adjust pet restraining device 12a. The second auto-adjust pet restraining device 12a has hook 40a snapped onto ring 38 first auto-adjust pet restraining device 12. First auto-adjust pet restraining device 12 is substantially the same multi-use pet restraining device 12 discussed in FIG. 1 thru 5 which has main loop 13, ring 38, and hook 40. Second auto-adjust pet restraining device 12a is substantially the same as auto-adjust pet restraining device 12. Second auto-adjust pet restraining device 12a has main loop 13a, hook 40a.

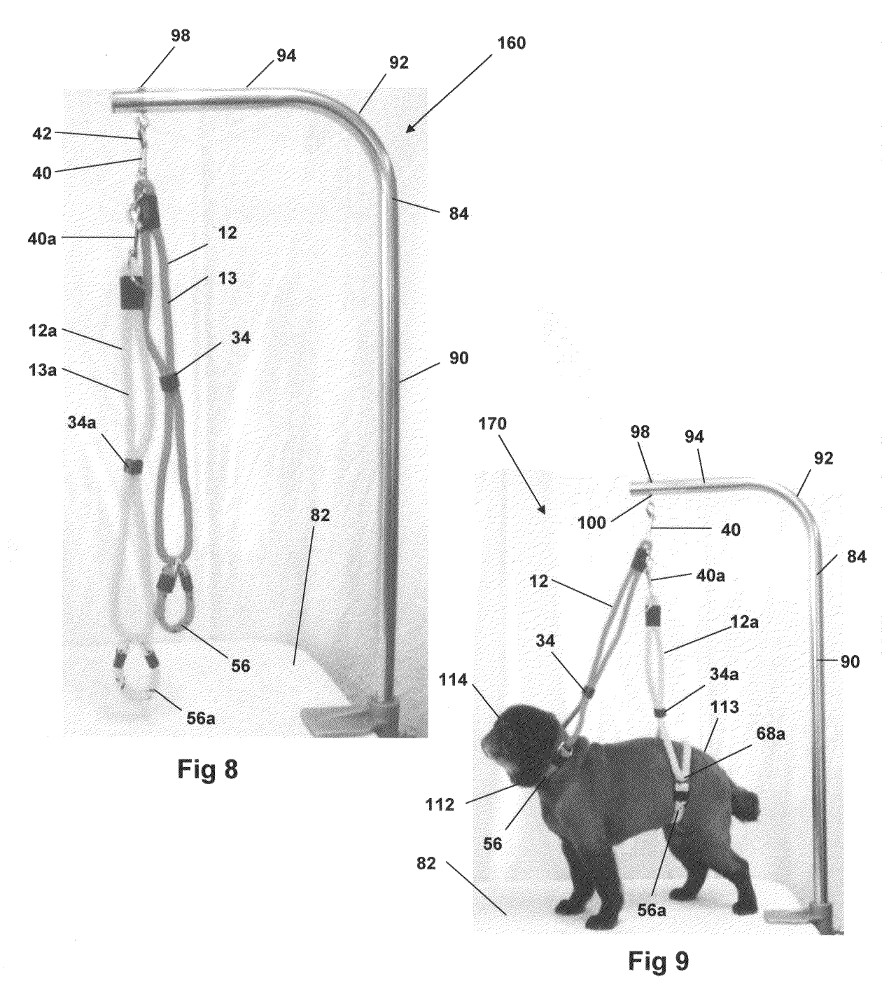

Shown generally at 160 in FIG. 8. is a side view of a first auto-adjust pet restraining device 12 and a second auto-adjust pet restraining device 12a hanging from a grooming arm, above grooming table 82. The second auto-adjust pet restraining device 12a has hook 40a snapped onto ring 38 first auto-adjust pet restraining device 12. First auto-adjust pet restraining device 12 is substantially the same auto-adjust pet restraining device 12 discussed in FIGS. 1 thru 5 which has main loop 13 strap 56, ring 38, hook 40 and sliding snugger 34. Second auto-adjust pet restraining device 12a is substantially the same as multi-use pet restraining device 12. Second auto-adjust pet restraining device 12a has main loop 13a, strap 56a, hook 40a and sliding snugger 34a. Grooming arm 84 has a vertical section 90 a curved section 92 and a horizontal section 94. Grooming arm terminates in end 96 and has bolt 98 that has a loop 100 with hook 40 of the auto-adjust grooming device 13 fastened thereto.

Shown generally at 170 in FIG. 9 is a side view of a first auto-adjust pet restraining device 12 and a second auto-adjust pet restraining device 12a hanging from a grooming arm, above grooming table 82. The first auto-adjust pet restraining device 12 is being utilized to restrain the neck 112 of dog 114. The second auto-adjust pet restraining device 12a is being utilized to restrain the rear portion 113 of dog 114. The second auto-adjust pet restraining device 12a has hook 40a snapped onto ring 38 first auto-adjust pet restraining device 12. First auto-adjust pet restraining device 12 is substantially the same auto-adjust pet restraining device 12 discussed in FIG. 1 thru 5 which has main loop 13 strap 56, ring 38, hook 40 and sliding snugger 34. Second auto-adjust pet restraining device 12a is substantially the same as auto-adjust pet restraining device 12. Second auto-adjust pet restraining device 12a has main loop 13a strap 56a, hook 40a and sliding snugger 34a.

Grooming arm 84 has a vertical section 90 a curved section 92 and a horizontal section 94. Grooming arm terminates in end 96 and has bolt 98 that has a loop 100 that hook 40 of the auto-adjust grooming device 12 is fastened thereto.

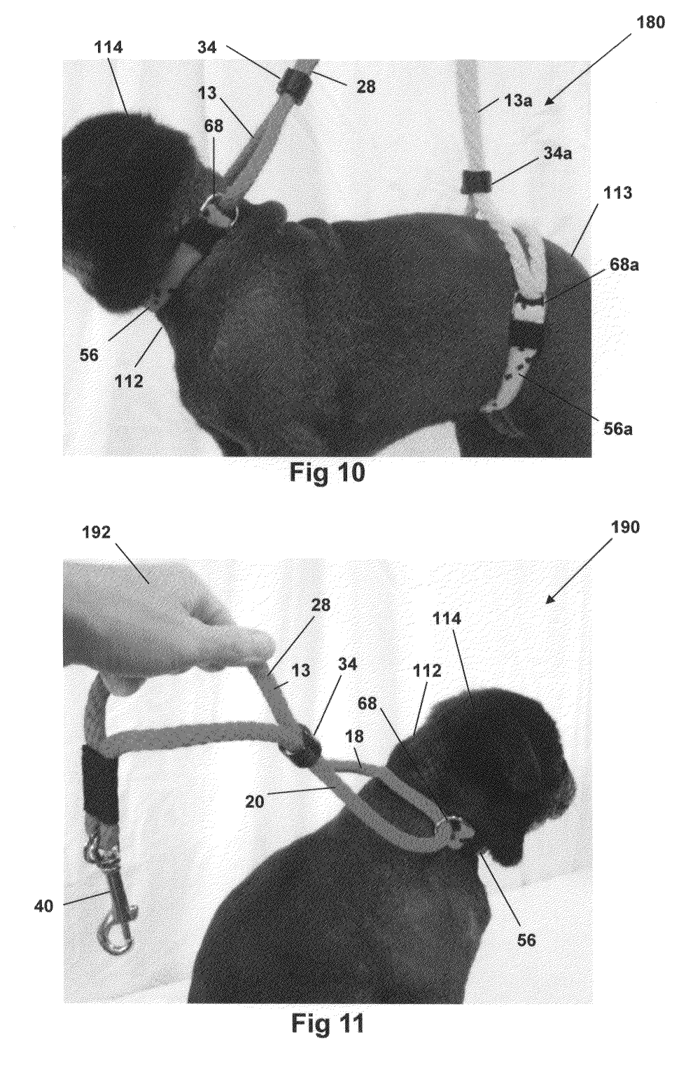

Shown generally at 180 in FIG. 10. is a close up side view of a first auto-adjust pet restraining device 12 and a second auto-adjust pet restraining device 12a. The first auto-adjust pet restraining device 12 is being utilized to restrain the neck 112 of dog 114. The second auto-adjust pet restraining device 12a is being utilized to restrain the rear portion 113 of dog 114. First auto-adjust pet restraining device 12 is substantially the same auto-adjust pet restraining device 12 discussed in FIG. 1 thru 5 which has main loop 13, strap 56, ring 68 and sliding snugger 34. Second auto-adjust pet restraining device 12a is substantially the same as auto-adjust pet restraining device 12. Second auto-adjust pet restraining device 12a has main loop 13a strap 56a, ring 68a, and sliding snugger is 34a.

Shown generally at 190 in FIG. 11 is a side view of a dog restrained by the auto-adjust pet restraining device 12. This shows how the top loop 28 on the auto-adjust restraining device 12 can fit a hand 192 so that the auto-adjust restraining device can be utilized as a leash. Auto-adjust pet restraining device 12 is substantially the same auto-adjust pet restraining device 12 discussed in FIG. 1 thru 5 which has main loop 13, bottom loop 18, top loop 28, strap 56, hook 40 and sliding snugger 34. Auto-adjust pet restraining device 12 is being utilized to restrain the neck 112 of dog 114.

### Description of the Prior Art

In FIG. 12 is shown generally shown at 200 is a top view of two prior art pet restraining devices. These devices are commonly referred to as grooming loops. The first grooming loop 202 has main loop 204 has a top end 205 and a bottom end 206. Main loop 202 has a bottom loop 212 that has first side 214 and a second side 216. Main loop 204 has a top loop 223 that has first side 224 and a second side 226. Sliding snugger 220 slides along main loop 204 and forms bottom loop 212 and top loop 223. Top end 205 has ring 230 secured thereto and a hook 232. Hook 232 has end that opens.

The second grooming loop 240 has a first end 242 that has a fastening loop 243 and a loop end 244. End 246 has a ring 248. Restraining loop 249 is formed to restrain pets. This generally is referred to a choker style grooming loop.

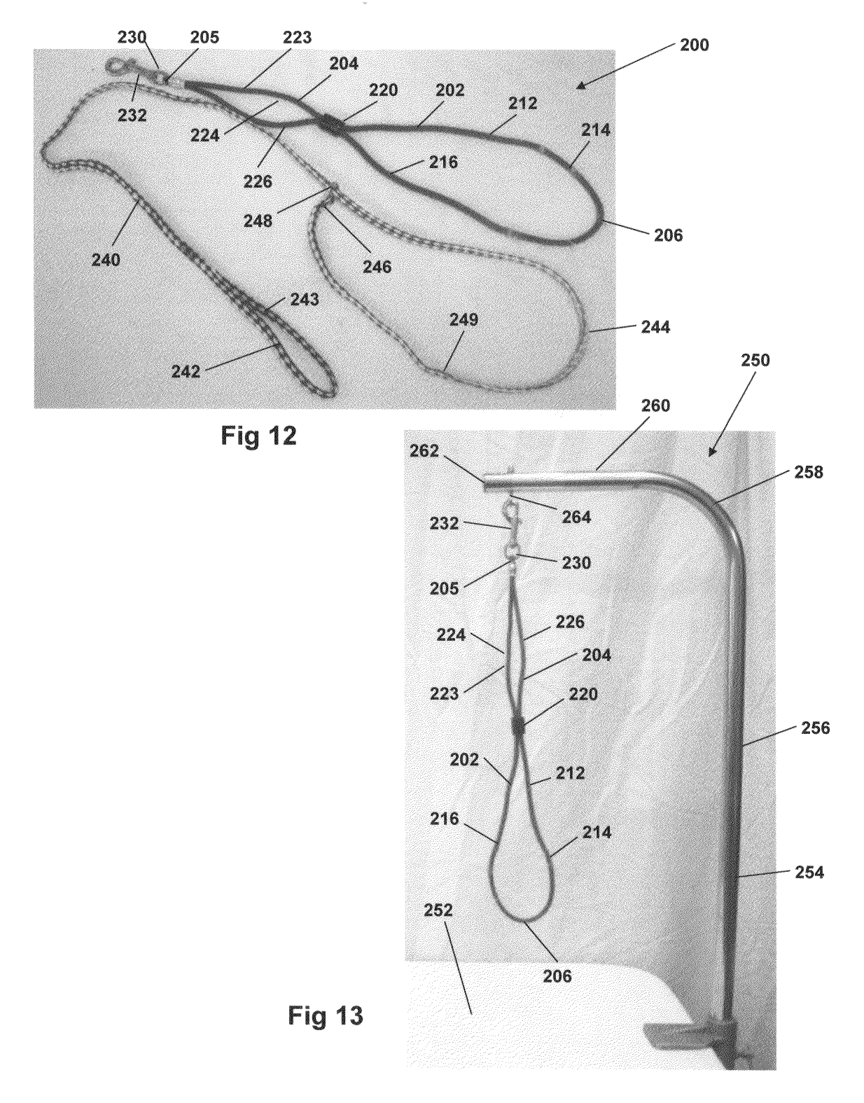

In FIG. 13 is shown generally shown at 250 is a front view a prior art grooming loop 202 hanging from a grooming arm 254. Grooming loop 202 has main loop 204 that has a top end 205 and a bottom end 206. Main loop 204 has a bottom is loop 212 that has first side 214 and a second side 216. Main loop 204 has a top loop 223 that has first side 224 and a second side 226. Sliding snugger 220 slides along main loop 204 and forms bottom loop 212 and top loop 223. Top of main loop 205 has ring 230 secured thereto and a hook 232. Hook 232 has end that opens. Surface of grooming table 252 is where a pet would be positioned. Grooming arm 254 has a vertical section 256 a curved section 258 and a horizontal section 260. Grooming arm terminates in end 262 that has a loop 264 that hook 232 of the prior art grooming loop 202 is fastened thereto.

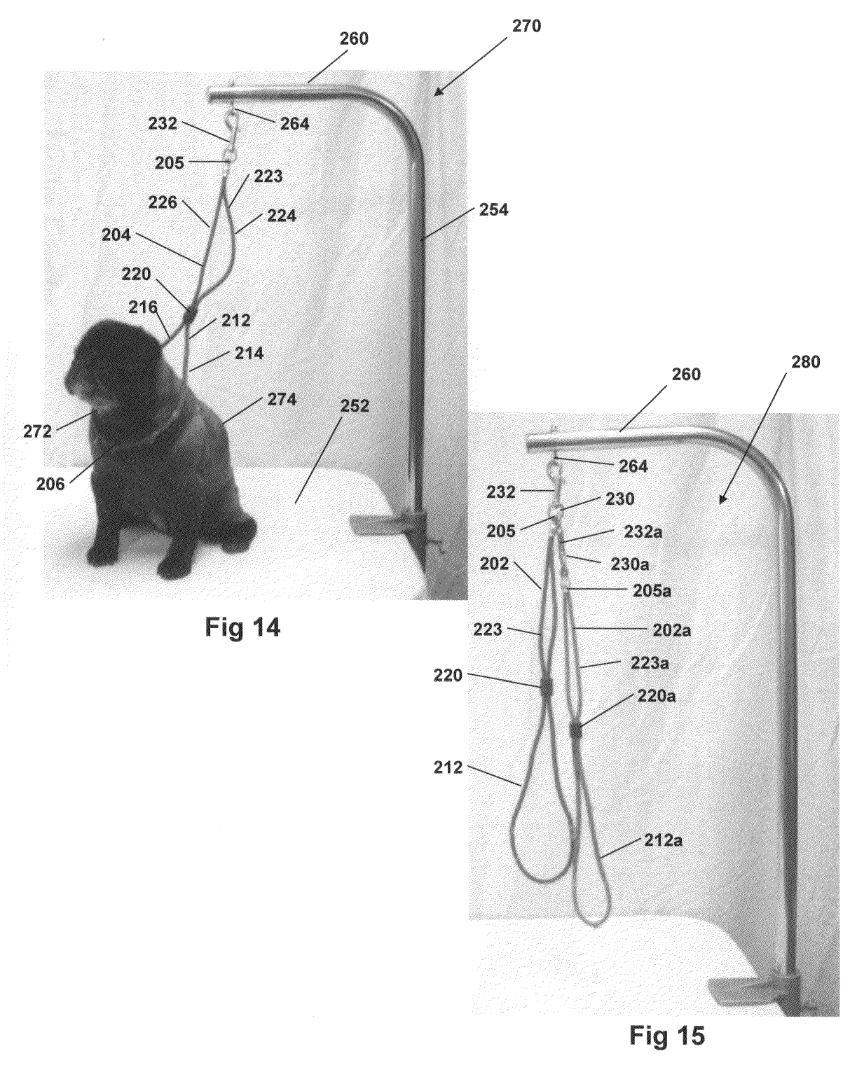

In FIG. 14 is shown generally shown at 270 is a front view a prior art grooming loop 202 hanging from a grooming arm 254 with grooming loop 202 around the neck 272 of dog 274. Grooming loop 202 has main loop 204 has a top end 205 and a bottom end 206. Main loop 202 has a bottom loop 212 that has first side 214 and a second side 216. Main loop 204 has a top loop 223 that has first side 224 and a second side 226. Sliding snugger 220 slides along main loop 204 and forms bottom loop 212 and top loop 223. Top of main loop 205 has ring 230 secured thereto and a hook 232. Hook 232 has end that opens. Surface of grooming table 252 is where dog 274 is positioned. Grooming arm 254 has a vertical section 256 a curved section 258 and a horizontal section 260. Grooming arm terminates in end 262 that has a loop 264 that hook 232 of the prior art grooming loop is fastened thereto. All of the restraining forces of this prior art grooming device are directed at throat area of the pet when the pet is restrained.

In FIG. 15 is shown generally shown at 280 is a front view a two prior art grooming loops hanging from a grooming arm 260. First grooming loop 202 has a bottom loop 212 and a top loop 223. Top of main loop 205 has ring 230 secured thereto and a hook 232. Hook 232 has end that opens and is attached to loop 264 of grooming arm 260. Second grooming loop 202a has a bottom loop 212a and a top loop 223a. Sliding snugger 220a slides and forms bottom loop 212a and top loop 223a. Top loop of main loop 205a has ring 230a secured thereto and a hook 232a. Hook 232a has end that opens. Hook 232a on second grooming loop 202a is fastened to loop 230 on first grooming loop 202.

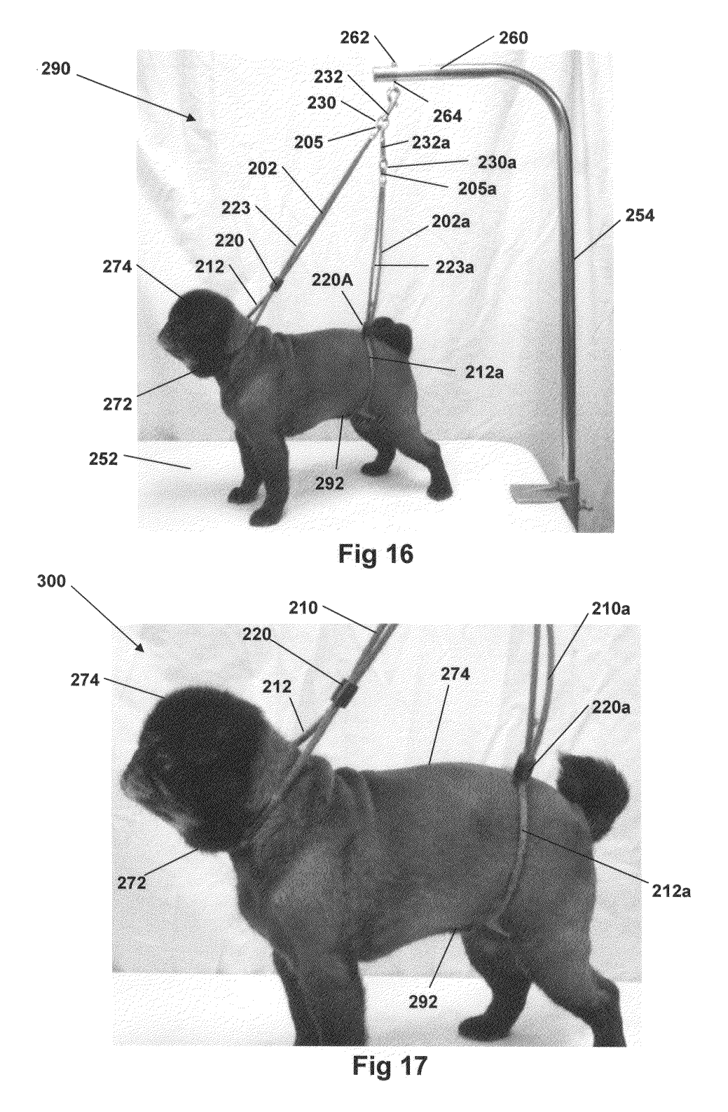

In FIG. 16 is shown generally shown at 290 is a front view a two prior art grooming loops hanging from a grooming arm 260 with a dog 274 being restrained by the prior art grooming loops. First grooming loop 202 has a bottom loop 212 and a top loop 223. Sliding snugger 220 slides and forms bottom loop 212 and top loop 223. Top of main loop 205 has ring 230 secured thereto and a hook 232. Hook 232 is fastened to loop 264 of grooming arm 254. Bottom loop 212 of first grooming loop 202 is positioned around neck 272 of dog 274. All of the restraining forces of this prior art grooming device are directed at throat area of the pet when the pet is retained.

Second grooming loop 202a has a bottom loop 212a and a top loop 223a. Sliding snugger 220a slides and forms bottom loop 212a and top loop 223a. Top loop of main loop 205a has ring 230a secured thereto and a hook 232a. Hook 232a has end that opens. Hook 232a on second grooming loop 202a is fastened to loop 230 on first grooming loop 202. Bottom loop 212a of second grooming loop 202a is positioned around belly 292 of dog 274. All of the restraining forces of this prior art grooming device are directed at the sensitive under belly area of the pet when the pet is retained.

In FIG. 17 is shown generally shown at 300 is a closeup view of two prior art grooming loops hanging from a grooming arm with a dog 274 being restrained by the prior art grooming loops. First grooming loop 202 has a bottom loop 212. Sliding snugger 220 slides and forms bottom loop 212. Bottom loop 212 of first grooming loop 202 is positioned around neck 272 of dog 274. All of the restraining forces of this prior art grooming device are directed at the sensitive throat area of the pet when the pet is restrained.

Second grooming loop 202a has a bottom loop 212a. Sliding snugger 220a slides and forms bottom loop 212a. Bottom loop 212a of second grooming loop 202a is positioned around belly 292 of dog 274. All of the restraining forces of this prior art grooming device are directed at the sensitive under belly area of the pet when the pet is restrained.

The objects and advantages of the invention will become apparent when the drawings are studied in conjunction with reading the following description and the claims.

This invention having been described in its presently contemplated best mode, it is clear that it is susceptible to numerous, variations, modifications, modes and embodiments within the ability of those skilled in the art and without departing from the true spirit and scope of the novel concepts or principles of this invention. Also, it is to be understood that the phraseology and terminology employed herein are for the purpose of description and should not be regarded as limiting. It should be understood that the preferred embodiment has been shown and described and that all changes and modifications that come within the spirit of the invention are desired to be protected. The invention is capable of other embodiments and of being practiced and carried out in various ways. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Accordingly, the scope of the invention is defined by the scope of the following claims. What is claimed as new and desired to be secured by United States Letters Patent is:

1. A self adjusting animal restraining device: comprising:
a flexible loop having a first end and a second end;
said flexible loop having a first side and a second side; said first end of said flexible loop for restraining an animal;
a flexible strap that has a first end and a second end;
said first end of said flexible strap having a ring incorporated thereon; said first side of said flexible loop passes through said ring on said first end of said flexible strap; said ring on said first end of said flexible strap sized so that said ring can slide freely along said first side of said flexible loop;
said second end of said flexible strap having a ring incorporated thereon; said second side of said flexible loop passes through said ring on said second end of said flexible strap; said ring on said second end of said flexible strap sized so that said ring can slide freely along said second side of said flexible loop;
said flexible strap having a length that is sized to partially extend around the neck of said animal;
said flexible loop and said flexible strap designed to that when a tension force is applied to said second end of said flexible loop, a uniform restraining force is applied around the perimeter of the neck of said animal when said neck of said animal is restrained between said first end of said flexible loop and said flexible strap.

2. The animal restraining device of claim 1 wherein said rings are made of rigid material.

3. The animal restraining device of claim 1 wherein said rings are made of rigid plastic material, or a metal material, or any combination thereof.

4. The animal restraining device of claim 1 wherein said rings have a round shape, or a “D” shape, or a square shape, or a rectangular shape or any combination thereof.

5. The animal restraining device of claim 1 including means for fastening said rings to said flexible strap.

6. The animal restraining device of claim 1 wherein said second end of said flexible loop has a fastening means incorporated thereon.

7. The animal restraining device of claim 1 including a hook that is fastened to said second end of said flexible loop.

8. The animal restraining device of claim 1 including a ring that is fastened to said second end of said flexible loop.

9. The animal restraining device of claim 1 wherein said flexible loop is made of polypropylene, or nylon, or leather, or cotton, or hemp, or manila, or polyester, or any flexible synthetic filament material, or any combination thereof.

10. The animal restraining device of claim 1 wherein said flexible strap is made of polypropylene, or nylon, or leather, or cotton, or hemp, or manila, or polyester, or any flexible synthetic filament material, or any combination thereof.

11. The animal restraining device of claim 1 wherein said flexible loop has round shape or a flat shape or any combination thereof.

12. The animal restraining device of claim 1 wherein said flexible strap is round shape or a flat shape or any combination thereof.

13. The animal restraining device of claim 1 including a sliding snugger that slides along said flexible loop.

14. The animal restraining device of claim 1 including a label that has information thereon.

15. The animal restraining device of claim 1 wherein said flexible loop is designed to be utilized as a leash.

16. The animal restraining device of claim 1 wherein said restraining device is sized to restrain a dog or a cat.

17. A self adjusting animal restraining device comprising:
a flexible loop having a first end and a second end;
said flexible loop having a first side and a second side; said first end of said flexible loop for restraining an animal;
said second end of said flexible loop having a fastening means incorporated thereon;
a flexible strap that has a first end and a second end;
said first end of said flexible strap having a ring incorporated thereon; said first side of said flexible loop passes through said ring on said first end of said flexible strap; said ring on said first end of said flexible strap sized so that said ring can slide freely along said first side of said flexible loop;
said second end of said flexible strap having a ring incorporated thereon; said second side of said flexible loop passes through said ring on said second end of said flexible strap; said ring on said second end of said flexible strap sized so that said ring can slide freely along said second side of said flexible loop;
said flexible strap having a length that is sized to partially extend around the neck of said animal;
said flexible loop and said flexible strap designed to that when a tension force is applied to said second end of said flexible loop, a uniform restraining force is applied around the perimeter of the neck of said animal when said neck of said animal is restrained between said first end of said flexible loop and said flexible strap.

18. The animal restraining device of claim 17 wherein said fastening means is a hook.

19. The animal restraining device of claim 17 including a sliding snugger that slides along said flexible loop.

20. A self adjusting animal restraining device comprising:
a flexible loop having a first end and a second end;
said flexible loop having a first side and a second side;
said first end of said flexible loop for restraining an animal;
a flexible strap that has a first end and a second end;
said first end of said flexible strap having a aperture incorporated thereon; said first side of said flexible loop passes through said aperture on said first end of said flexible strap; said aperture on said first end of said flexible strap sized so that said ring can slide freely along said first side of said flexible loop;
said second end of said flexible strap having a aperture incorporated thereon; said second side of said flexible loop passes through said aperture on said second end of said flexible strap; said aperture on said second end of said flexible strap sized so that said aperture can slide freely along said second side of said flexible loop;
said strap having a length that is sized to partially extend around the neck of said animal;
said flexible loop and said flexible strap designed to that when a tension force is applied to said second end of said flexible loop, a uniform restraining force is applied around the perimeter of the neck of said animal when said neck of said animal is restrained between said first end of said flexible loop and said flexible strap.
